(19) United States
(12) Patent Application Publication
(10) Pub. No.: US 2011/0202627 A1
(43) Pub. Date: Aug. 18, 2011

(54) DATA TRANSFER APPARATUS AND DATA TRANSFER METHOD

(75) Inventors: Fumiharu Nakayama, Kanagawa-ken (JP); Yasunori Sato, Shizuoka-ken (JP); Jun Sasano, Tokyo-to (JP); Tomohide Oka, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/026,538

(22) Filed: Feb. 14, 2011

Related U.S. Application Data
(60) Provisional application No. 61/305,395, filed on Feb. 17, 2010.
(60) Provisional application No. 61/305,397, filed on Feb. 17, 2010.
(60) Provisional application No. 61/350,201, filed on Jun. 1, 2010.

(51) Int. Cl. G06F 15/16

(52) U.S. Cl. 709/217

(57) ABSTRACT

According to one embodiment, a data transfer apparatus includes a managing unit and a transfer unit. The managing unit manages a transmission folder and plural output conditions in association with each other. The transfer unit transfers, on the basis of the plural output conditions, one or more files stored in the transmission folder.

### CROSS-REFERENCE TO RELATED APPLICATIONS

This application is based upon and claims the benefit of priority from U.S. Provisional Application No. 61/305,395, filed on Feb. 17, 2010; No. 61/305,397, filed on Feb. 17, 2010; and No. 61/350,201, filed on Jun. 1, 2010; the entire contents of all of which are incorporated herein by reference.

### FIELD

Embodiments described herein relate generally to a data transfer apparatus and a data transfer method.

### BACKGROUND

In recent years, various proposals concerning image transmission techniques have been made. For example, an image transmitting apparatus includes a file sharing function that makes use of a network. The image transmitting apparatus can share a file stored in a network sharing folder with an external apparatus through the network.

The image transmitting apparatus includes an image transmitting function that makes use of the network. The image transmitting apparatus can transmit a file stored in a transmission folder to a designated transmission destination (a telephone number or an email address). In this case, for example, operation for storing a file in the transmission folder and operation for designating a transmission destination of the file stored in the transmission folder are performed.

The image transmitting apparatus includes a scanner. The image transmitting apparatus can transmit image data read by the scanner to a designated transmission destination. In this case, the image data is transmitted on a real time basis according to reading of an image. However, the read image data is not accumulated in a folder or the like.

### BRIEF DESCRIPTION OF THE DRAWINGS

FIG. 1 is a diagram of an example of a schematic configuration of an image transmission system according to first and second embodiments;

FIG. 2 is a diagram for explaining an example of image transfer according to the first embodiment;

FIG. 3 is a flowchart for explaining an example of the image transfer according to the first embodiment;

FIG. 4 is a diagram of an example of the structure of a network sharing folder laid open on a network according to the second embodiment;

FIG. 5 is a flowchart for explaining an example of image transfer according to the second embodiment; and

FIG. 6 is an example of a setting screen for a folder managed by file management information.

### DETAILED DESCRIPTION

In general, according to one embodiment, a data transfer apparatus includes a managing unit and a transfer unit. The managing unit manages a transmission folder and plural output conditions in association with each other. The transfer unit transfers, on the basis of the plural output conditions, one or more files stored in the transmission folder.

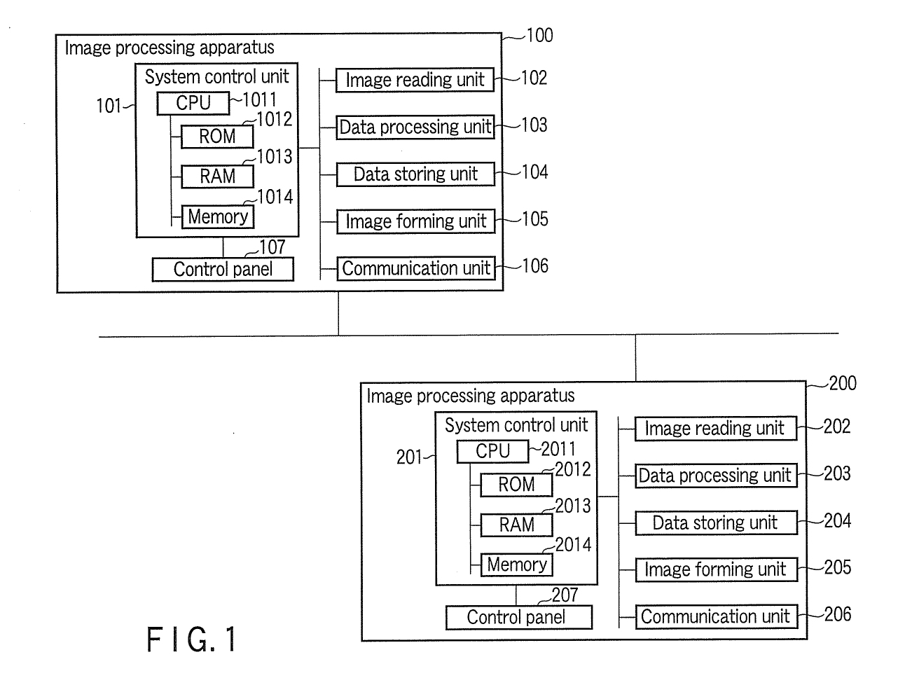

FIG. 1 is a diagram of an example of a schematic configuration of an image transmission system according to first and second embodiments. As shown in FIG. 1, the image transmission system includes an image processing apparatus (an image transfer apparatus) 100 and an image processing apparatus 200 such as MFPs (multifunction printers). The image processing apparatus 100 and the image processing apparatus 200 are connected via a network. For example, the image processing apparatus 100 transmits various data and the image processing apparatus 200 receives the various data.

It is also conceivable that various communication apparatuses are interposed in a communication path between the image processing apparatus 100 and the image processing apparatus 200. For example, the image processing apparatus 100 transmits various data to the image processing apparatus 200 via one or more communication apparatuses (a gateway (G/W) and an NGN (next generation network)). In other words, the image processing apparatus 200 receives the various data via the one or more communication apparatuses.

Data communication in which the image processing apparatus 100 serves as a transmitter and the image processing apparatus 200 servers as a receiver is explained below. However, the image processing apparatuses 100 and 200 are not limited to only the data communication. For example, only one of the image processing apparatuses 100 and 200 can be replaced with various communication apparatuses such as a personal computer or both the image processing apparatuses 100 and 200 can be replaced with the various communication apparatuses.

As shown in FIG. 1, the image processing apparatus 100 includes a system control unit 101, an image reading unit 102, a data processing unit 103, a data storing unit 104, an image forming unit 105, a communication unit 106, and a control panel 107.

The system control unit 101 includes a CPU 1011, a ROM 1012, a RAM 1013, and a nonvolatile memory 1014. The CPU 1011 controls, according to various inputs via the control panel 107, image reading by the image reading unit 102, image formation by the image forming unit 105, data processing by the data processing unit 103, communication by the communication unit 106, and the like.

The image reading unit 102 reads a document image and outputs image data corresponding to the document image on the basis of an instruction from the CPU 1011. The data storing unit 104 stores the image data. The data processing unit 103 compresses the image data and generates compressed image data on the basis of an instruction from the CPU 1011. The image forming unit 105 forms an image based on the image data on the basis of an instruction from the CPU 1011.

The communication unit 106 communicates with the various communication apparatuses via the network, transmits image data to the various communication apparatuses, and receives image data transmitted from the various communication apparatuses.

### First Embodiment

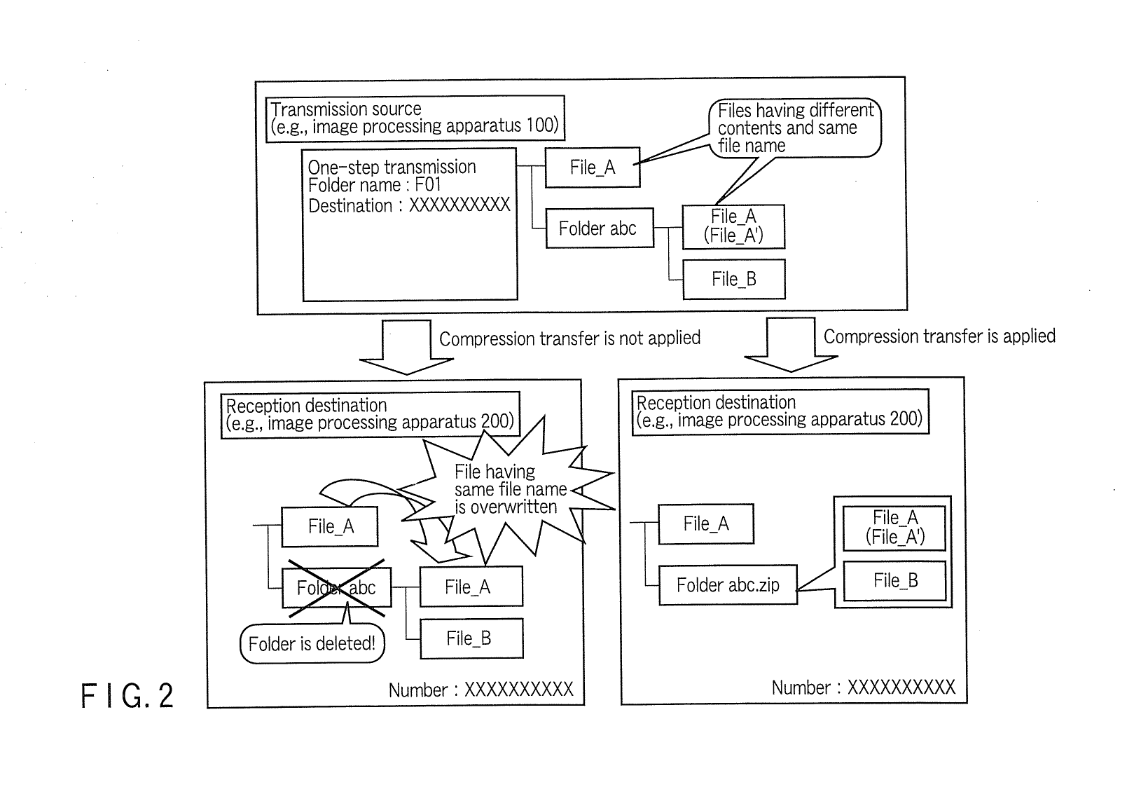

For example, the data storing unit 104 of the image processing apparatus 100 stores data having structure shown in FIG. 2 (a transmission source). Specifically, the data storing unit 104 stores a one-step transmission folder, stores File_A and a folder abc (a sub-folder) belonging to the one-step transmission folder, and stores File_A and File_B belonging to the folder abc. File_A belonging to the one-step transmission folder and File_A belonging to the folder abc are folders having the same file name and different contents. In the following explanation, to facilitate understanding of the explanation, File_A belonging to the folder abc is defined as File_A′. File_A, File_A′, and File_B are files having extensions in file names.

For example, the nonvolatile memory 1014 of the image processing apparatus 100 stores file management information. The CPU 1011 manages files on the basis of the file management information. For example, the file management information includes first storage control information. The first storage control information is information for instructing the CPU 1011 to store a read image in the folder abc. The CPU 1011 stores, on the basis of the first storage control information, image data (File_A) acquired by reading by the image reading unit 102 in the folder abc. The file management information includes second storage control information. The second storage control information is information for instructing the CPU 1011 to store a received image in the one-step transmission folder. The CPU 1011 stores, on the basis of the second storage control information, image data (File_A′ and File_B) from various network apparatuses received by the communication unit 106 in the folder abc.

The file management information includes first output control information (output conditions). The first output control information is information for controlling output (transmission) of the one-step transmission folder. The first output control information includes information indicating one or more transmission destinations (telephone numbers, email addresses, etc.) of one or more files stored in the one-step transmission folder.

Further, the file management information includes second output control information (output conditions). The second output control information is information for controlling output (transmission) of the one-step transmission folder. The second output control information includes information indicating conversion transfer for converting each of one or more sub-folders stored in the one-step transmission folder into one file and transferring the converted file. As an example, the second output control information includes information indicating compression transfer for compressing a sub-folder stored in the one-step transmission folder to generate a compressed file and transferring the compressed file.

The CPU 1011 instructs, based on the second output control information, a data processing unit 103 to convert the sub-folder stored in the one-step transmission folder into a file. According to the instruction, the data processing unit 103 converts the sub-folder stored in the one-step transmission folder into a file. For example, the CPU 1011 instructs, on the basis of the second output control information, the data processing unit 103 to compress the folder abc stored in the one-step transmission folder to generate a compressed file abc. According to the instruction, the data processing unit 103 compresses the folder abc and generates the compressed file abc corresponding to the folder abc. For example, the data processing unit 103 compresses File_A′ and File_B stored in the folder abc to generate the compressed file abc. In other words, the compressed file abc includes compressed data of File_A′ and File_B. The compressed file abc is a file having an extension.

Further, the CPU 1011 controls, on the basis of the first output control information, the communication unit 106 to transmit (transfer) File_A and the compressed file abc stored in the one-step transmission folder to the transmission destination. According to the control, the communication unit 106 transmits (transfers) File_A and the compressed file abc stored in the one-step transmission folder to the transmission destination.

For example, if the image processing apparatus 200 corresponds to the transmission destination, the image processing apparatus 200 receives File_A and the compressed file abc. The data storing unit 204 of the image processing apparatus 200 stores data having structure shown in FIG. 2 (a reception destination, the compression transfer is applied). In other words, the data storing unit 204 of the image processing apparatus 200 stores File_A and a folder abc.zip (the compressed file abc). The folder abc.zip (the compressed file abc) includes compressed data of File_A′ and File_B. Further, the data processing unit 203 of the image processing apparatus 200 decompresses the folder abc.zip (the compressed file abc) and generates the folder abc including File_A′ and File_B. Consequently, the data storing unit 204 of the image processing apparatus 200 can construct (store) data structure stored in the data storing unit 104 of the image processing apparatus 100.

As explained above, the image processing apparatus 100 can automatically transmit (automatically transfer), according to the first and second output control information, a file stored in the one-step transmission folder to a designated transmission destination and can automatically compress a sub-folder stored in the one-step transmission folder and automatically transmit (automatically transfer) the sub-folder to the designated transmission destination. In other words, the image processing apparatus 100 can automatically transmit (automatically transfer), making use of the one-step transmission folder in which plural output conditions (the first and second output control information) can be set, one or more files and one or more compressed files stored in the one-step transmission folder to one or more transmission destinations.

The CPU 1011 can instruct, on the basis of the second output control information, the data processing unit 103 to automatically compress all the sub-folders stored in the one-step transmission folder. According to the instruction, the data processing unit 103 can automatically compress all the sub-folders stored in the one-step transmission folder. Alternatively, the CPU 1011 may instruct the data processing unit 103 to automatically compress, among all the sub-folders stored in the one-step transmission folder, a predetermined sub-folder in which a file having a file name same as a file name of a file stored in the one-step transmission folder is stored. According to the instruction, the data processing unit 103 may automatically compress only the predetermined sub-folder among all the sub-folders stored in the one-step transmission folder.

On the other hand, if the image processing apparatus 100 does not set the second output control information, for example, the image processing apparatus 200 cannot correctly receive File_A stored in the one-step transmission folder and File_A′ stored in the folder abc in the one-step transmission folder.

For example, the CPU 1011 of the image processing apparatus 100 controls, on the basis of the first output control information (the second output control information cannot be used because the second output control information is not set), the communication unit 106 to transmit (transfer) File_A and the folder abc (or File_A, File_A′, and File_B) stored in the one-step transmission folder to the transmission destination. According to the control, the communication unit 106 transmits (transfers) File_A and the folder abc (or File_A, File_A′, and File_B) stored in the one-step transmission folder to the transmission destination.

For example, if the image processing apparatus 200 corresponds to the transmission destination, the image processing apparatus 200 receives File_A and the folder abc (or File_A, File_A′, and File_B). The data storing unit 204 of the image processing apparatus 200 stores data having structure shown in FIG. 2 (a reception destination (the compression transfer is not applied)). In other words, the data storing unit 204 of the image processing apparatus 200 stores File_A, File_A′, and File_B. The image processing apparatus 200 deletes the folder abc, regards File_A and File_A′ as the same file, and, for example, overwrites File_A′ with File_A.

In this way, if the compression transfer is not applied, in some case, the image processing apparatus 200 cannot correctly receive File_A stored in the one-step transmission folder and File_A′ stored in the folder abc in the one-step transmission folder.

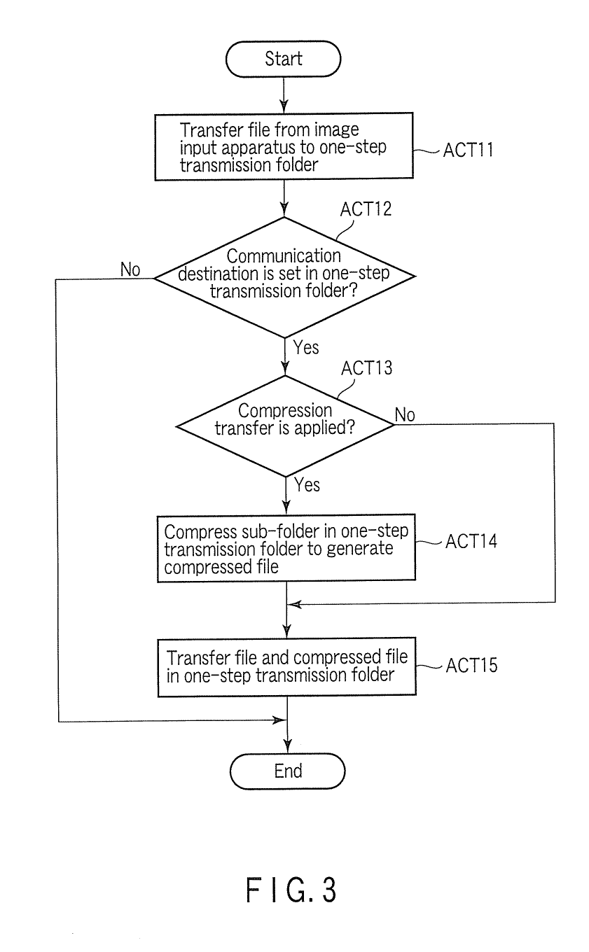

An example of data transfer according to the first embodiment is explained with reference to FIG. 3. For example, the CPU 1011 of the image processing apparatus 100 monitors the one-step transmission folder.

For example, when an image input apparatus connected to the network transfers an image file (e.g., File_A′) to the one-step transmission folder as a destination (ACT 11), the communication unit 106 of the image processing apparatus 100 receives the image file. The CPU 1011 controls the data storing unit 104 to store the image file in the folder abc of the one-step transmission folder. The data storing unit 104 stores the image file in the folder abc.

The CPU 1011 determines, on the basis of the first and second output control information and a state of the one-step transmission folder, whether the compression transfer should be applied. For example, if a sub-folder is formed in the one-step transmission folder, the CPU 1011 determines that the compression transfer is applied. Alternatively, if a file name of at least one file of the sub-folder in the one-step transmission folder is the same as a file name of at least one file in the one-step transmission folder, the CPU 1011 determines that the compression transfer is applied.

The CPU 1011 instructs, on the basis of the first and second output control information and the determination of the compression transfer, the data processing unit 103 to compress the sub-folder stored in the one-step transmission folder (YES in ACT 12 and YES in ACT 13). According to the instruction, the data processing unit 103 compresses the sub-folder stored in the one-step transmission folder and generates a compressed file corresponding to the sub-folder (ACT 14).

Further, the CPU 1011 controls, on the basis of the first output control information, the communication unit 106 to transmit (transfer) a file and a compressed file stored in the one-step transmission folder to a transmission destination. According to the control, the communication unit 106 transmits (transfers) the file and the compressed file stored in the one-step transmission folder to the transmission destination (ACT 15).

The first embodiment is summarized below.

The image processing apparatus (the image transfer apparatus) according to the first embodiment is connected to the network, includes the network sharing folder, and manages the network sharing folder and an address (IPv4/IPv6) or telephone number information of a communication partner in association with each other. For example, a network apparatus connected to the network stores a file in the network sharing folder using a network file transfer protocol (SMB or NFS). According to the storage of the file, the image processing apparatus (the image transfer apparatus) automatically transfers the file stored in the network sharing folder using the address or the telephone number information associated with the network sharing folder. In other words, after the file is stored in the network sharing folder, even if a user does not designate a communication partner, the image processing apparatus (the image transfer apparatus) automatically transfers, on the basis of the address or the telephone number information associated with the network sharing folder, the file stored in the network sharing folder.

Moreover, the image processing apparatus (the image transfer apparatus) compresses the folder stored in the network sharing folder to generate a compressed file and automatically transfers the compressed file on the basis of the address or the telephone number information associated with the network sharing folder. Consequently, even if a large number of sub-folders are created under the network sharing folder and a file name of a file under the network sharing folder and a file name of a file under a predetermined sub-folder are the same, the image processing apparatus (the image transfer apparatus) can correctly transmit these files. The image processing apparatus (the image receiving apparatus) can correctly receive all the files (can correctly receive plural files having the same file name and different file contents) without overwriting the files by mistake (without creating plural files having the same file name and the same file contents).

In short, the image processing apparatus (the image transfer apparatus) according to the first embodiment is summarized as explained below.

(1) The image processing apparatus (the image transfer apparatus) includes a file sharing function on a network and includes a transmitting function for storing data in a transmission folder on the network and automatically transmitting the data stored in the transmission folder.

(2) Even if plural files are stored in the transmission folder, a sub-folder is formed in the transmission folder, plural files are stored in the sub-folder, and, for example, plural files having the same file name are present, the image processing apparatus (the image transfer apparatus) can correctly transmit all the files in the transmission folder. For example, the image processing apparatus compresses the entire sub-folder of the transmission folder to convert the sub-folder into a compressed file and transmits the compressed file. This makes it possible to prevent overwriting of plural files having the same file name.

(3) The image receiving apparatus can receive the compressed file, decrypt the compressed file, and construct a folder having structure substantially the same as the structure of the transmission folder of the image processing apparatus (the image transfer apparatus).

### Second Embodiment

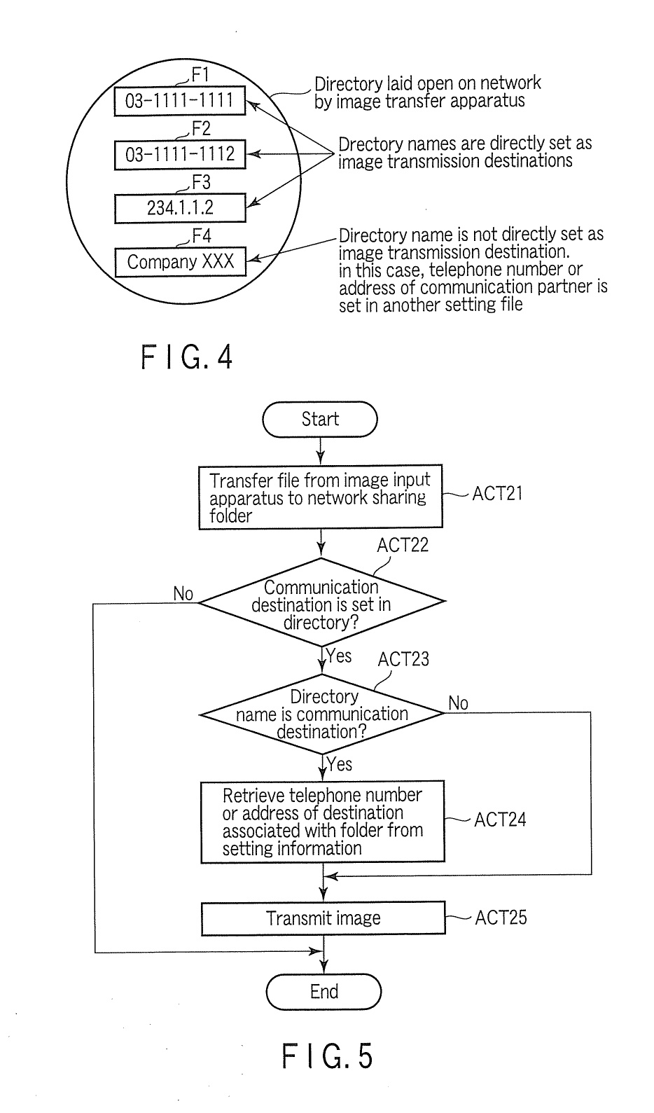

For example, the data storing unit 104 of the image processing apparatus 100 stores a network sharing folder laid open on a network. The network sharing folder includes plural folders (plural directories). For example, as shown in FIG. 4, the data storing unit 104 stores plural folders (plural directories). As the plural folders, for example, a first folder F1 (a folder 03-1111-1111), a second folder F2 (a folder 03-1111-1112), a third folder F3 (234.1.1.2), and a fourth folder F4 (Kabushiki Kaisha . . . ) are assumed. In the following explanation, a folder and a directory are substantially synonymous.

For example, the nonvolatile memory 1014 of the image processing apparatus 100 stores file management information. The CPU 1011 manages files on the basis of the file management information. For example, the file management information includes first output control information (output conditions). The first output control information is information for controlling output (transmission) of the first folder F1 and is information for setting a folder name of the first folder F1 as a transmission destination and instructing the CPU 1011 to transmit files stored in the first folder F1 to the transmission destination. The CPU 1011 controls, on the basis of the first output control information, the communication unit 106 to transmit (transfer) the files stored in the first folder F1 to the transmission destination (the folder name). According to the control, the communication unit 106 transmits (transfers) the files stored in the first folder F1 to the transmission destination (a telephone number 03-1111-1111).

The file management information includes second output control information (output conditions). The second output control information is information for controlling output (transmission) of the second folder F2 and is information for setting a folder name of the second folder F2 as a transmission destination and instructing the CPU 1011 to transmit files stored in the second folder F2 to the transmission destination. The CPU 1011 controls, on the basis of the second output control information, the communication unit 106 to transmit (transfer) the files stored in the second folder F2 to the transmission destination (the folder name). According to the control, the communication unit 106 transmits (transfers) the files stored in the second folder F2 to the transmission destination (a telephone number 03-1111-1112).

The file management information includes third output control information (output conditions). The third output control information is information for controlling output (transmission) of the third folder F3 and is information for setting a folder name of the third folder F3 as a transmission destination and instructing the CPU 1011 to transmit files stored in the third folder F3 to the transmission destination. The CPU 1011 controls, on the basis of the third output control information, the communication unit 106 to transmit (transfer) the files stored in the third folder F3 to the transmission destination (the folder name). According to the control, the communication unit 106 transmits (transfers) the files stored in the third folder F3 to the transmission destination (an address 234.1.1.2).

The file management information includes fourth output control information (output conditions). The fourth output control information is information for controlling output (transmission) of the fourth folder F4, includes information indicating a transmission destination (a telephone number, an address, etc.) of files stored in the fourth folder F4, and is information for instructing the CPU 1011 to transmit the files stored in the fourth folder F4 to the transmission destination. The CPU 1011 controls, on the basis of the fourth output control information, the communication unit 106 to transmit (transfer) the files stored in the fourth folder F4 to the transmission destination (the telephone number, the address, etc.). According to the control, the communication unit 106 transmits (transfers) the files stored in the fourth folder F4 to the transmission destination (the telephone number, the address, etc.).

The file management information can also include fifth output control information (output conditions). For example, the fifth output control information is information for controlling output (transmission) of the third folder F3 and is information for instructing printout of files stored in the third folder F3. The CPU 1011 controls, on the basis of the third and fifth output control information, the communication unit 106 to transmit (transfer) the files stored in the third folder F3 to the transmission destination of the folder name of the third folder F3. In addition, the CPU 1011 instructs printout of the files stored in the third folder F3. According to the control and the instruction, the communication unit 106 transmits (transfers) the files stored in the third folder F3 to the transmission destination and instructs printout of the files.

For example, if the image processing apparatus 200 corresponds to the transmission destination, the image processing apparatus 200 receives the files stored in the third folder F3 and receives the instruction for printout of the files. According to the reception of the files and the instruction, the data storing unit 204 of the image processing apparatus 200 stores the received files and the image forming unit 205 of the image processing apparatus 200 prints out an image based on the received files.

The file management information can also include sixth output control information (output conditions). For example, the sixth output control information is information for controlling output (transmission) of the fourth folder F4 and is information for instructing printout of the files stored in the fourth folder F4. The CPU 1011 controls, on the basis of the fourth and sixth output control information, the communication unit 106 to transmit (transfer) the files stored in the fourth folder F4 to a transmission destination (a telephone number, an address, etc.). In addition, the CPU 1011 instructs printout of the files stored in the fourth folder F4. According to the control and the instruction, the communication unit 106 transmits (transfers) the files stored in the fourth folder F4 to the transmission destination (the telephone number, the address, etc.) and, in addition, instructs printout.

For example, if the image processing apparatus 200 corresponds to the transmission destination, the image processing apparatus 200 receives the files stored in the fourth folder F4 and receives the instruction for printout of the files. According to the reception of the files and the instruction, the data storing unit 204 of the image processing apparatus 200 stores the received files and the image forming unit 205 of the image processing apparatus 200 prints out an image based on the received files.

As explained above, the image processing apparatus 100 can automatically transmit (automatically transfer), according to the first to fourth output control information, files stored in the folders to a set transmission destination. The image processing apparatus 100 can automatically transmit (automatically transfer), making use of the folder (the third folder F3 or the fourth folder F4) in which the plural output conditions (the third and fifth output control information or the fourth and sixth output control information) are set, one or more files stored in the folder to one or more transmission destinations and cause the transmission destination (e.g., the image processing apparatus 200) to automatically print out the transmission files.

An example of data transfer according to the second embodiment is explained with reference to FIG. 5. For example, the CPU 1011 of the image processing apparatus 100 monitors the first folder F1, the second folder F2, the third folder F3, and the fourth folder F4.

For example, when an image input apparatus connected to the network transfers an image file to the one-step transmission folder as a destination (ACT 21), the communication unit 106 of the image processing apparatus 100 receives the image file. The CPU 1011 controls the data storing unit 104 to store the image file in the first folder F1 of the network sharing folder. The data storing unit 104 stores the image file in the first folder F1.

The CPU 1011 detects that the image file is stored in the first folder F1 and controls, on the basis of the file management information, output of the image file stored in the first folder F1. For example, the CPU 1011 controls, on the basis of the first output control information, the communication unit 106 to transmit (transfer) the image file stored in the first folder F1 to a transmission destination (a folder name) (YES in ACT 22 and YES in ACT 23). According to the control, the communication unit 106 transmits (transfers) the image file stored in the first folder F1 to the transmission destination (the telephone number 03-1111-1111) (ACT 25).

If the CPU 1011 controls the data storing unit 104 to store the image file in the fourth folder F4 of the network sharing folder and the data storing unit 104 stores the image file in the fourth folder F4, the CPU 1011 controls, on the basis of the file management information, output of the image file stored in the fourth folder F4. For example, the CPU 1011 retrieves a transmission destination (a telephone number, an address, etc.) associated with the fourth folder F4 and controls the communication unit 106 to transmit (transfer) the image file stored in the fourth folder F4 to the retrieved transmission destination (YES in ACT 22, NO in ACT 23, and ACT 24). According to the control, the communication unit 106 transmits (transfers) the image file stored in the fourth folder F4 to the retrieved transmission destination (ACT 25).

The second embodiment is summarized below.

The image processing apparatus (the image transfer apparatus) according to the second embodiment is connected to the network, includes the network sharing folder, and manages the network sharing folder and an address (IPv4/IPv6) or telephone number information of a communication partner in association with each other. For example, a network apparatus connected to the network stores a file in the network sharing folder using a network file transfer protocol (SMB or NFS). According to the storage of the file, the image processing apparatus (the image transfer apparatus) automatically transfers the file stored in the network sharing folder using the address or the telephone number information associated with the network sharing folder. In other words, after the file is stored in the network sharing folder, even if a user does not designate a communication partner, the image processing apparatus (the image transfer apparatus) automatically transfers, on the basis of the address or the telephone number information associated with the network sharing folder, the file stored in the network sharing folder.

Moreover, the image processing apparatus (the image transfer apparatus) can also directly set a folder name of the network sharing folder as a transmission destination and automatically transfer the file stored in the network sharing folder to the transmission destination.

In short, the image processing apparatus (the image transfer apparatus) according to the second embodiment is summarized as explained below.

(1) The image processing apparatus (the image transfer apparatus) includes a file sharing function on a network and further includes a transmitting function for storing data in a transmission folder on the network, setting a folder name of the transmission folder as a transmission destination, and automatically transmitting the data stored in the transmission folder to the transmission destination.

(2) The image processing apparatus (the image transfer apparatus) includes the file sharing function on the network and further includes a transmitting function for storing data in a transmission folder on the network and automatically transmitting the data stored in the transmission folder to a telephone number, an address, or the like associated with the transmission folder.

(3) If a network in use is mainly an NGN (next generation network), the image processing apparatus (the image transfer apparatus) uses a telephone number as a partner designating method.

The file management information explained in the first and second embodiments is explained more in detail below.

Processing conditions indicating how to cause a transmission destination to process a transmission file are set in a folder (the transmission folder, etc.). In other words, the file management information includes processing conditions such as the fifth output control information (control information for causing the transmission destination to print out the transmission file). Alternatively, the file management information includes the processing conditions such as the sixth output control information (control information for causing the transmission destination to store the transmission file). Alternatively, the file management information includes processing conditions such as seventh output control information (control information for causing the transmission destination to store and print out the transmission file).

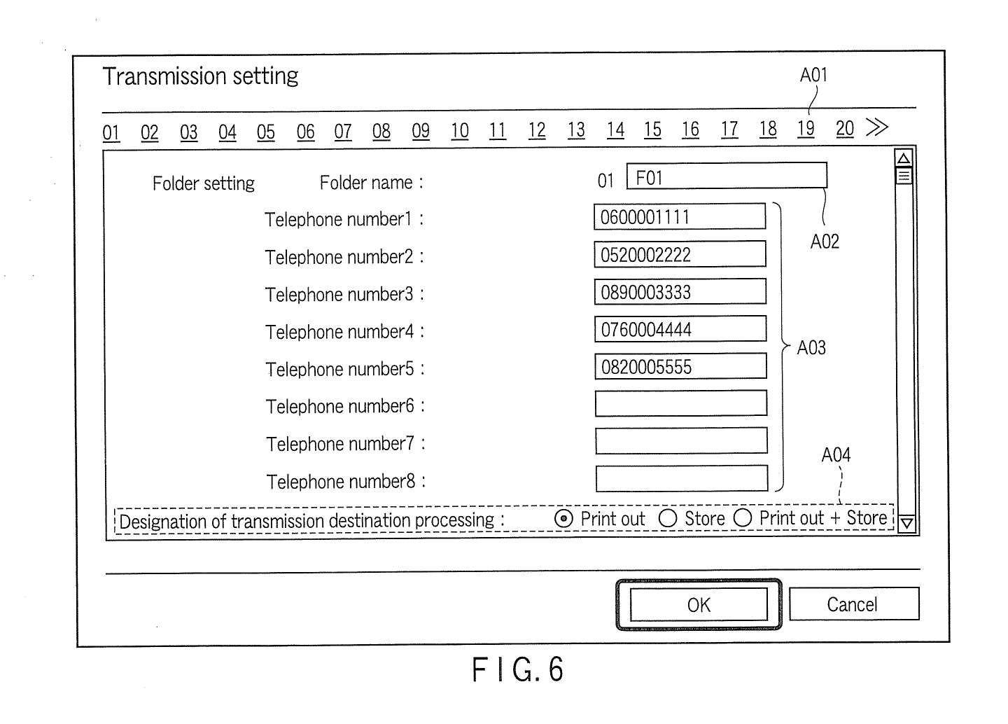

An example of a method of setting the processing conditions such as the fifth to seventh output control information is explained. FIG. 6 is an example of a setting screen for a folder managed by the file management information. A user sets the processing conditions via, for example, the control panel 107 of the image processing apparatus 100 or a user interface of a user apparatus such as a computer.

When the image processing apparatus 100 receives an instruction for creation of a file or a setting change from the user apparatus such as the computer via the control panel 107 or the communication unit 106, the image processing apparatus 100 displays the setting screen shown in FIG. 6 on the user interface of the user apparatus via the control panel 107 or the communication unit 106.

As shown in FIG. 6, the setting screen includes a folder selection area A01 for selecting a folder to be created or to be subjected to a setting change. For example, in FIG. 6, a state in which a folder F01 is selected is shown. A folder name of the folder F01 is input to an input area A02 of the folder F01. A transmission address is input to an input area A03. The transmission address input to the input area A03 is set in association with the selected folder F01.

The information processing apparatus 100 receives, from the user apparatus via the control panel 107 or the communication unit 106, processing conditions indicating how to cause the transmission destination to process a transmission file. For example, the setting screen includes a transmission destination processing condition designation area A04. The transmission destination processing condition designation area A04 includes “print out”, “store”, and “store+print out”. The transmission destination processing condition designation area A04 is set for each folder. The image processing apparatus 100 transmits, on the basis of destination information set in the input area A03, the processing condition designated in the transmission destination processing condition designation area A04 and the transmission file to a transmission destination (e.g., the image processing apparatus 200). The transmission destination (e.g., the image processing apparatus 200) receives the processing conditions and the transmission file and processes the received transmission file on the basis of the received processing conditions.

If “print out” is included in the processing conditions, the transmission destination (e.g., the image processing apparatus 200) prints out the received transmission file. Alternatively, if “print out” is included in the processing conditions, the transmission destination (e.g., the image processing apparatus 200) transfers the received transmission file to another image forming apparatus registered in advance as an apparatus that the user causes to execute printout.

If “store” is included in the processing conditions, the transmission destination (e.g., the image processing apparatus 200) stores the received transmission file in a designated storage destination (storage device).

If “store+print out” is included in the processing conditions, the transmission destination (e.g., the image processing apparatus 200) stores the received transmission file in the designated storage destination (storage device) and prints out the received transmission file. Alternatively, if “store+print out” is included in the processing conditions, the transmission destination (e.g., the image processing apparatus 200) stores the received transmission file in the designated storage destination (storage device) and transfers the received transmission file to another image forming apparatus registered in advance as an apparatus that the user causes to execute printout.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data transfer apparatus comprising:
a managing unit configured to manage a transmission folder and plural output conditions in association with each other; and
a transfer unit configured to transfer, on the basis of the plural output conditions, one or more files stored in the transmission folder.

2. The apparatus according to claim 1, wherein
the managing unit manages the transmission folder and a first output condition indicating one or more transmission destinations in association with each other, and
the transfer unit transfers, on the basis of the first output condition, one or more files stored in the transmission folder to the transmission destinations.

3. The apparatus according to claim 1, further comprising a folder processing unit, wherein
the managing unit manages the transmission folder and a first output condition indicating one or more transmission destinations in association with each other and manages the transmission folder and a second output condition indicating compression transfer in association with each other,
the folder processing unit compresses, on the basis of the second output condition, a first folder stored in the transmission folder to generate a first compressed file corresponding to the first folder, and
the transfer unit transfers, on the basis of the first output condition, the first compressed file and a second file stored in the first folder to the transmission destinations.

4. The apparatus according to claim 1, wherein
the managing unit manages the transmission folder and a first output condition for setting a name of the transmission folder as a transmission destination in association with each other, and
the transfer unit transfers, on the basis of the first output condition, the one or more files stored in the transmission folder to a folder name transmission destination set from the name of the transfer folder.

5. The apparatus according to claim 1, wherein
the managing unit manages a first transmission folder and a first output condition indicating one or more transmission destinations in association with each other and manages a second transmission folder and a second output condition for setting a name of the second transmission folder as a transmission destination in association with each other, and
the transfer unit transfers, on the basis of the first output condition, one or more files stored in the first transmission folder to the transmission destinations and transfers, on the basis of the second output condition, one or more files stored in the second transmission folder to a folder name transmission destination set from the name of the second transmission folder.

6. The apparatus according to claim 1, wherein
the managing unit manages the transmission folder and a first output condition indicating one or more transmission destinations in association with each other and manages the transmission folder and a second output condition indicating printout in association with each other, and
the transfer unit transfers, on the basis of the first and second output conditions, one or more files stored in the transmission folder to the transmission destinations and instructs the transmission destinations to print out the transferred files.

7. A data transfer method comprising:
managing a transmission folder and plural output conditions in association with each other; and
transferring, on the basis of the plural output conditions, one or more files stored in the transmission folder.

8. The method according to claim 7, wherein
the managing includes managing the transmission folder and a first output condition indicating one or more transmission destinations in association with each other, and
the transferring includes transferring, on the basis of the first output condition, one or more files stored in the transmission folder to the transmission destinations.

9. The method according to claim 7, further comprising processing a folder, wherein
the managing includes managing the transmission folder and a first output condition indicating one or more transmission destinations in association with each other and managing the transmission folder and a second output condition indicating compression transfer in association with each other,
the processing the folder includes compressing, on the basis of the second output condition, a first folder stored in the transmission folder to generate a first compressed file corresponding to the first folder, and
the transferring includes transferring, on the basis of the first output condition, the first compressed file and a second file stored in the first folder to the transmission destinations.

10. The method according to claim 7, wherein
the managing includes managing the transmission folder and a first output condition for setting a name of the transmission folder as a transmission destination in association with each other, and
the transferring includes transferring, on the basis of the first output condition, the one or more files stored in the transmission folder to a folder name transmission destination set from the name of the transfer folder.

11. The method according to claim 7, wherein
the managing includes managing a first transmission folder and a first output condition indicating one or more transmission destinations in association with each other and managing a second transmission folder and a second output condition for setting a name of the second transmission folder as a transmission destination in association with each other, and
the transferring includes transferring, on the basis of the first output condition, one or more files stored in the first transmission folder to the transmission destinations and transferring, on the basis of the second output condition, one or more files stored in the second transmission folder to a folder name transmission destination set from the name of the second transmission folder.

12. The method according to claim 7, wherein
the managing includes managing the transmission folder and a first output condition indicating one or more transmission destinations in association with each other and managing the transmission folder and a second output condition indicating printout in association with each other, and
the transferring includes transferring, on the basis of the first and second output conditions, one or more files stored in the transmission folder to the transmission destinations and instructing the transmission destinations to print out the transferred files.

13. A data transfer apparatus comprising:
means for managing a transmission folder and plural output conditions in association with each other; and
means for transferring, on the basis of the plural output conditions, one or more files stored in the transmission folder.

14. The apparatus according to claim 13, wherein
the managing means manages the transmission folder and a first output condition indicating one or more transmission destinations in association with each other, and
the transferring means transfers, on the basis of the first output condition, one or more files stored in the transmission folder to the transmission destinations.

15. The apparatus according to claim 13, further comprising means for processing a folder, wherein
the managing means manages the transmission folder and a first output condition indicating one or more transmission destinations in association with each other and manages the transmission folder and a second output condition indicating compression transfer in association with each other,
the folder processing means compresses, on the basis of the second output condition, a first folder stored in the transmission folder to generate a first compressed file corresponding to the first folder, and
the transferring means transfers, on the basis of the first output condition, the first compressed file and a second file stored in the first folder to the transmission destinations.

16. The apparatus according to claim 13, wherein
the managing means manages the transmission folder and a first output condition for setting a name of the transmission folder as a transmission destination in association with each other, and
the transferring means transfers, on the basis of the first output condition, the one or more files stored in the transmission folder to a folder name transmission destination set from the name of the transfer folder.

17. The apparatus according to claim 13, wherein
the managing means manages a first transmission folder and a first output condition indicating one or more transmission destinations in association with each other and manages a second transmission folder and a second output condition for setting a name of the second transmission folder as a transmission destination in association with each other, and
the transferring means transfers, on the basis of the first output condition, one or more files stored in the first transmission folder to the transmission destinations and transfers, on the basis of the second output condition, one or more files stored in the second transmission folder to a folder name transmission destination set from the name of the second transmission folder.

18. The apparatus according to claim 13, wherein
the managing means manages the transmission folder and a first output condition indicating one or more transmission destinations in association with each other and manages the transmission folder and a second output condition indicating printout in association with each other, and
the transferring means transfers, on the basis of the first and second output conditions, one or more files stored in the transmission folder to the transmission destinations and instructs the transmission destinations to print out the transferred files.
